(19) United States
(12) Patent Application Publication
(10) Pub. No.: US 2015/0217680 A1
(43) Pub. Date: Aug. 6, 2015

(54) WARNING DEVICE

(71) Applicant: Chris Agajanian Presents, Inc., San Pedro, CA (US)

(72) Inventor: Chris AGAJANIAN, San Pedro, CA (US)

(21) Appl. No.: 14/614,374

(22) Filed: Feb. 4, 2015

Related U.S. Application Data
(60) Provisional application No. 61/935,752, filed on Feb. 4, 2014.

(51) Int. Cl. B60Q 1/26

(52) U.S. Cl. CPC B60Q 1/26

(57) ABSTRACT

The system utilizes the so-called “third brake-light” on the rear of an automobile to provide indication to other drivers that one or more occupants in a vehicle are not wearing a safety belt. The system provides a sensor to determine if an occupant is present and if their safety belt is latched. If not, the system causes the third brake light to flash slowly. This warns other drivers of a dangerous situation, allowing the other drivers to perhaps provide greater distance between themselves and the vehicle, or to change lanes so as to reduce the possibility of a collision with unprotected occupants. The system also informs law enforcement of a violation of safety belt laws, allowing the situation to be corrected by law enforcement pulling over the vehicle and issuing a warning or citation. In one embodiment, the system is implemented with a separate indicator of the lack of safety belt or an unsafe condition, such as an additional light.

This patent application claims priority to U.S. Provisional Patent Application Ser. No. 61/935,752 filed on Feb. 4, 2014, which is incorporated by reference herein in its entirety.

### BACKGROUND OF THE SYSTEM

Car safety has been an ongoing concern since the invention of the automobile. One of the most successful safety innovations for automobiles is the seat belt. Keeping an occupant of a vehicle (e.g. driver or passenger) in place is critical in reducing the possibility and extent of injury in a car accident. It is likely that an accident with a car that has unbelted occupants is more devastating, traumatic, costly and deadly than if the occupants had been wearing safety belts.

A vehicle carrying an occupant not using seatbelts creates a hazardous condition to not only the occupant inside that vehicle but also to the drivers of other cars around it. No one wants to cause injuries to others especially when those injuries could have been prevented. There are undue consequences that an innocent driver can suffer by crashing into a car when the occupants or driver of that car is not buckled up.

A car containing unbelted occupants is a hazard to the occupants and others and it would be a benefit to be able to know when such a condition exists.

### SUMMARY

The system utilizes the so-called “third brake-light” on the rear of an automobile to provide indication to other drivers that one or more occupants in a vehicle are not wearing a safety belt. The system provides a sensor to determine if an occupant is present and if their safety belt is latched. If not, the system causes the third brake light to flash slowly. This warns other drivers of a dangerous situation, allowing the other drivers to perhaps provide greater distance between themselves and the vehicle, or to change lanes so as to reduce the possibility of a collision with unprotected occupants. The system also informs law enforcement of a violation of safety belt laws, allowing the situation to be corrected by law enforcement pulling over the vehicle and issuing a warning or citation. In one embodiment, the system is implemented with a separate indicator of the lack of safety belt or an unsafe condition, such as an additional light.

### BRIEF DESCRIPTION OF THE DRAWINGS

FIG. 1 is a block diagram of an embodiment of the system.

FIG. 2 is a flow diagram illustrating the operation of an embodiment of the system.

FIG. 3 is block diagram of another embodiment of the system.

FIG. 4 is a block diagram of an example processing environment of the system.

### DETAILED DESCRIPTION OF THE SYSTEM

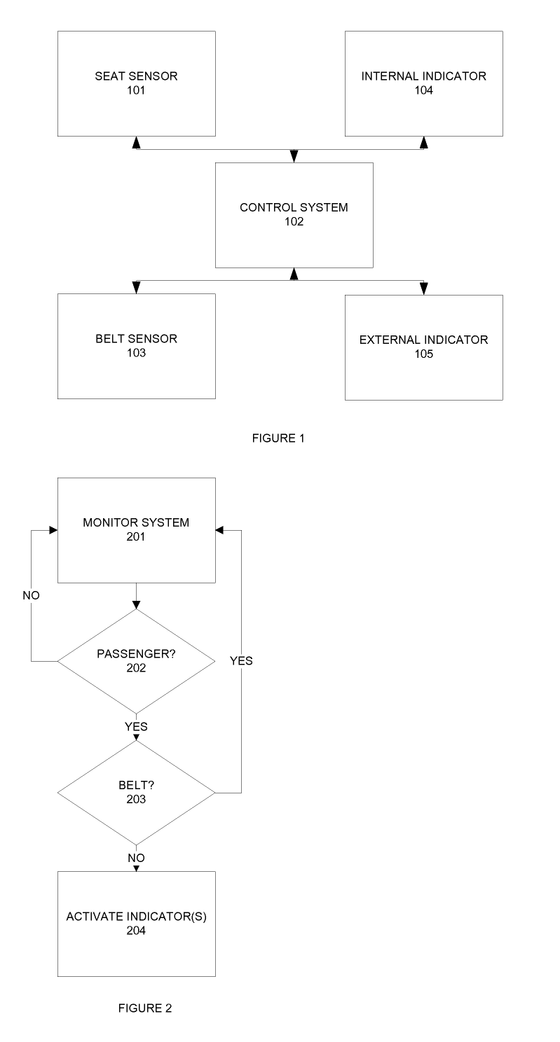

An embodiment of the system is illustrated in FIG. 1. A seat sensor 101 detects if an occupant is sitting in a seat in the vehicle. Many vehicles have such sensors both for occupant detection and in some cases, to coordinate with a vehicle air bag system to either arm or disable the airbag, depending on the weight of the person in the seat. For example, the air bag system may be disabled if the weight of the person is below a certain threshold, indicating an infant in a baby seat and/or a toddler.

The seat sensor 101 is coupled to the vehicle control system 102. The control system is the CPU based controller of functions in the automobile, including collecting data from various sensors and providing information, warnings, gauge levels, and other performance information. Safety belt sensor 103 is also coupled to the control system 102. The control system is also coupled to internal safety belt warning indicator 104 and external safety belt indicator 105.

If the system detects an occupant in a seat using sensor 101, and also detects that the safety belt for that seat is not fastened, the control system causes the internal safety belt warning indicator 104 to activate. This indicator 104 may combine a flashing or steady light with an audio warning, such as a buzzer, ding, or other suitable alert. This internal indicator often has a limited time of operation, (e.g. less than 60 seconds) and then is disabled, even if the safety belt remains unlatched. The warning may repeat periodically, depending on the vehicle.

When the system detects an unbelted occupant from sensors 101 and 103, the control system 102 also causes the external safety belt indicator to activate. In one embodiment, the external safety belt indicator is the third brake light, and the unbelted condition causes the brake light to flash slowly. In one embodiment, the rate of flashing is slower than would be the case if the emergency flashers were activated. In other instances, the external indicator may flash with some particular pattern, such as three slow and three fast repeatedly, indicating an SOS condition to other drivers. The system contemplates that the external safety belt indicator 105 will indicate in a manner that will distinguish it from other typical indicators of the third brake light, so that it will be understood by other drivers and law enforcement that there is a safety belt non-operation condition in the vehicle. As noted above, the external safety belt indicator 105 may be another external light on the vehicle or a new dedicated light on the vehicle. In addition, the external indicator can be differentiated by flashing or displaying in a different color, in addition to, or instead of, flashing in a particular pattern.

In one embodiment, the activation of the external safety belt indicator also causes other lights on the vehicle to indicate the condition, including lights on the front (e.g. amber hazard lights, fog lights, and the like) and/or side (e.g. turn signals, side mirror lights, and the like) of the vehicle.

The invention in one embodiment utilizes what is known as the third brake light to serve as the external indicator. The third brake light is the light that is mounted up high in the center of the rear of a vehicle so as to place it at the approximate eye level of approaching drivers. In other embodiments, other and/or additional external indicators may be utilized with the system.

FIG. 2 is a flow diagram of the operation of an embodiment of the system. At step 201 the system is engaged and monitors the vehicle. At decision block 202 it is determined if there is an occupant in the seat. If not, the system returns to step 201. If so, the system proceeds to decision block 203. At step 203, the system determines if the safety belt for the detected occupant is engaged. This may be by checking for a complete circuit in the latch and/or checking for extension of the safety belt from its rest position. If the belt is engaged, the system returns to step 201.

If the belt is not engaged at step 203, the system proceeds to step 204 and activates the indicator or indicators. This can include both internal and external indicators which may be activated as described above.

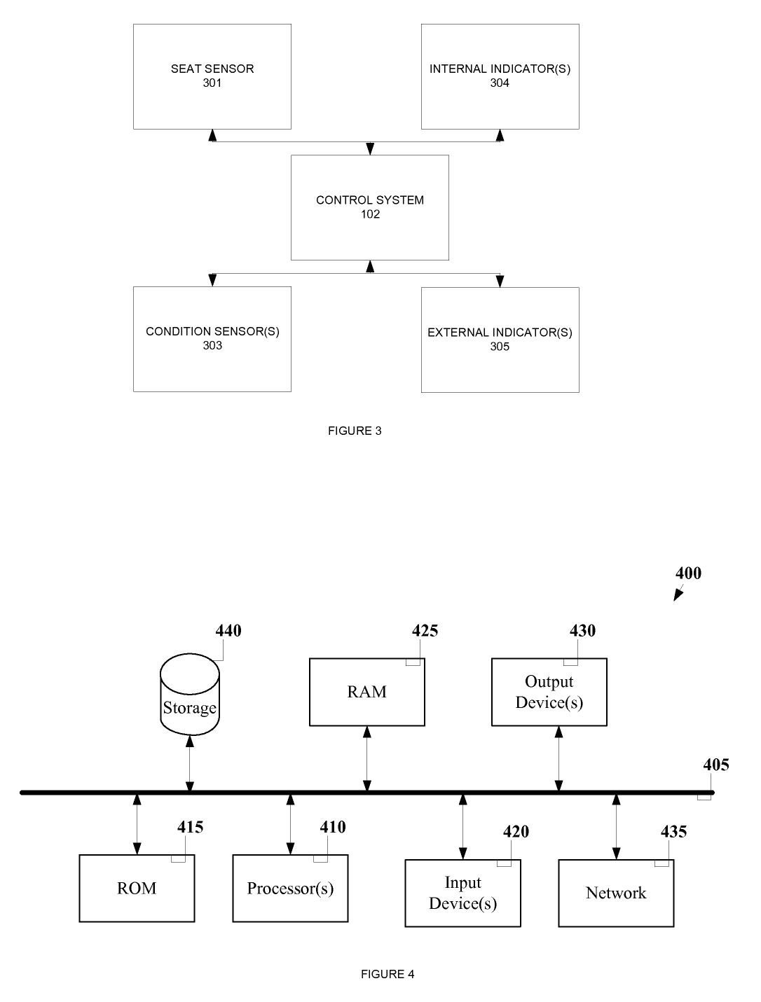

The system is not limited to indicating seat belt usage, but may also be used to indicate other conditions of the vehicle and/or occupants of a vehicle. Referring to FIG. 3, the system includes a seat sensor block 301 that is used to determine the presence or absence of an occupant in a particular seat. Although a seat sensor (e.g. weight sensor, capacitive touch sensor, and the like) is used in one embodiment, the system may also utilize some other method of detecting occupants, including optical scanning, RFID, keyless fobs, or any other suitable method of determining occupancy and position of occupants of a vehicle.

The system also includes condition sensor(s) 303 that are used to detect certain conditions that may be part of this embodiment and for which alerts may be generated and displayed, internally and/or externally. These sensors may be passive or active. Passive sensors can include detecting whether a condition has been met (e.g. seat belt usage, hands free device activation, door ajar, tire pressure, brake pad wear, low fluids, and the like. In other instances, a sensor may detect the presence of alcohol in the vehicle environment and trigger an alert and/or disable the vehicle. The system may include sensors for headlight failure, brake light failure, turn indicator failure, and the like.

In one embodiment the system may be in wireless communication with a licensing or registration agency to indicate the status of a driver's license and/or vehicle registration. If a license or registration is expired, the vehicle may initiate a visible alert on the external indicator so that law enforcement is aware of the driver and vehicle status. In other instances, the car may be automatically disabled until the license and/or registration is valid. In some cases, a driver's license may have restrictions on driving at night or driving with passengers. The system can determine if the license of the driver has such restrictions and disable the vehicle and/or provide some alert if those conditions are present. The system may require the driver to scan their license before driving so that such determination can be made. The system may also check for valid insurance from an available database and respond accordingly if there is no insurance, particularly in those states where drivers are required to have proof of automobile insurance when driving. The system may also check for outstanding warrants, criminal activity, stolen cars, and other circumstances where an alert can be sent out to authorities. In some case the alerts may be sent out silently and not to the driver.

In another embodiment the system may include more active sensors that require interaction with one or more occupants. For example, the system may require a driver to breathe into a breathalyzer, to enter a code, to perform an interactive step to indicate reaction time, and the like. The system may include memory in control system 102 to store baseline data about a driver and to compare real world driving behavior of the driver to prior metrics associated with the passive and active sensors. In this manner the system can tailor alerts to specific occupant history and conditions to better assess the need for alerts and/or disablement of the vehicle. The system could also apply to rental or leased vehicles to require that only the authorized driver can use the vehicle. This feature could be combined with any or all of the other features.

If one or more conditions have been detected, the system communicates via the controls system 102 to internal indicator(s) 304 and/or external indicators 305. The internal indicators can be a combination of audio and visual indicators to warn or alert the occupant of the triggered condition. The system may include a voice (e.g. text to speech, prerecorded, and the like) that states the condition to be managed.

The external indicators may include any number of methods of representation. If the third brake light, for example, is used as the sole external indicator, the system may flash a series of codes where each code represents one or more of the alert conditions. As noted above, this could be a variation of Morse code or any other representation that can indicate a particular condition. In one embodiment, the system may use a plurality of different colored lights and/or flashing patterns to represent one or more conditions.

In other embodiments, any existing external indicator that is presently on a vehicle could be used to provide alerts to other drivers of possible conditions associated with a vehicle. In one embodiment, one or more additional external indicators may be added to a vehicle to indicate vehicle and/or occupant conditions. In one embodiment a scrolling text display could be used to indicate one or more particular conditions. The text display could also have flashing patterns and/or colors associated with particular conditions, in addition to the text that describes the condition. In another embodiment, an external display may use iconography to indicate a vehicle and/or occupant condition, such as an icon of an unfastened seatbelt, an alcohol bottle, and the like.

### EXAMPLE COMPUTER SYSTEM

FIG. 4 illustrates an exemplary computer system 400 that may implement the system controller and other aspects of the system. The computer system includes various types of computer readable media and interfaces. The system includes a bus 405, processors 410, read only memory (ROM) 415, input device(s) 420, random access memory 425), output device(s) 430, a network component 435, and a permanent storage device 440.

The bus 405 the communicatively connects the internal devices and/or components of the computer system. For instance, the bus 405 communicatively connects the processor(s) 410 with the ROM 415, the RAM 425, and the permanent storage 440. The processor(s) 410 retrieve instructions from the memory units to execute processes of the invention.

The ROM 415 stores static instructions needed by the processor(s) 410 and other components of the computer system. The ROM may store the instructions necessary for the processor to execute the web server, web application, or other web services. The permanent storage 440 is a non-volatile memory that stores instructions and data when the computer system 400 is on or off. The permanent storage 440 is a read/write memory device, such as a hard disk or a flash drive. Storage media may be any available media that can be accessed by a computer. By way of example, the ROM could also be EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

The RAM 425 is a volatile read/write memory. The RAM 425 stores instructions needed by the processor(s) 410 at runtime. The bus 405 also connects input and output devices 420 and 430. The input devices enable the user to communicate information and select commands to the computer system. The input devices 420 may be a keyboard or a pointing device such as a mouse. The input devices 420 may also be a touch screen display capable of receiving touch interactions. The output device(s) 430 display images generated by the computer system. The output devices may include printers or display devices such as monitors.

The bus 405 also couples the computer system to a network 435. The computer system may be part of a local area network (LAN), a wide area network (WAN), the Internet, or an Intranet by using a network interface. The web service may be provided to the user through a web client, which receives information transmitted on the network 435 by the computer system 100.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for” or, in the case of a method claim, the element is recited using the phrase “step for.”

Thus, a warning system has been described.

What is claimed is:

1. A method of indicating a condition in a vehicle comprising:
detecting with a first sensor the presence of a condition associated with the vehicle;
providing the output of the sensor to a control system;
activating with the control system an external indicator on the vehicle that indicates the detected condition.

2. The method of claim 1 wherein the system further includes a second sensor coupled to the control system for detecting the presence of an occupant in the vehicle.

3. The method of claim 2 wherein the first condition is a failure to engage a seatbelt by the occupant.

4. The method of claim 3 wherein the external indicator is a third brake light of the vehicle.

5. The method of claim 4 wherein the third brake light flashes a pattern to indicate to others that a seat belt is not engaged.

6. The method of claim 5 wherein the pattern is three long flashes followed by three short flashes.

7. The method of claim 2 wherein the first condition is an invalid driver's license.

8. The method of claim 2 wherein the first condition is a detected alcohol level.

9. The method of claim 2 wherein the first condition is a limitation related to a license of the driver.

10. The method of claim 2 wherein the first condition is a lack of insurance.
